(19) United States
(12) Patent Application Publication
(10) Pub. No.: US 2010/0114647 A1
(43) Pub. Date: May 6, 2010

(54) SYSTEM AND METHOD FOR FOR GRANULAR INVENTORY FORECASTING OF ONLINE ADVERTISEMENT IMPRESSIONS

(75) Inventors: Victor K. Chu, Milpitas, CA (US); Long-Ji Lin, San Jose, CA (US)

Correspondence Address: Law Office of Robert Bolan, P.O. Box 36, Bellevue, WA, 98009, US

(73) Assignee: Yahoo! Inc., Sunnyvale, CA (US)

(21) Appl. No.: 12/262,080

(22) Filed: Oct. 30, 2008

(51) Int. Cl. G06Q 10/00; G06Q 50/00

(52) U.S. Cl. 705/10

(57) ABSTRACT

An improved system and method for granular inventory forecasting of online advertisement impressions is provided. An impression forecast data integrator may be provided that generates forecasted impression pools of advertisements by integrating impression pools of advertisements that share the same attributes and trend forecast data for web pages and advertisement placements on the web pages. Using the trend forecast data, an inventory forecast for a category may be calculated and an inventory forecast for an impression pool may be calculated. A daily forecasted inventory may then be produced for each impression pool by minimizing an objective function of squared errors of the difference between the daily forecasted inventory for each category and the sum of the daily forecasted inventory for each impression pool. The daily inventory forecast for each pool may be output.

### FIELD OF THE INVENTION

The invention relates generally to computer systems, and more particularly to an improved system and method for granular inventory forecasting of online advertisement impressions.

### BACKGROUND OF THE INVENTION

A major problem faced by an online advertising publisher is to forecast available inventory of advertisement impressions for sale to online advertisers. Online advertisers would like to target users visiting certain web pages with certain demographics, geographies, behavioral interests, as well as many other attributes. For example, an advertiser may want to target users in a publisher's website with the following profile: female, over 30 years old, with a behavioral interest in home improvement. Thus an online advertising publisher needs to make accurate forecasts for any combination of those attributes efficiently.

The problem of forecasting available inventory of advertisement impressions for sale to online advertisers that are untargeted is considerably easier to solve since it involves predicting available advertisement impressions for each advertising property managed by the online publisher. One method of solving this problem is described in U.S. Pat. No. 6,801,945, entitled “SYSTEMS AND METHODS FOR PREDICTING TRAFFIC ON INTERNET SITES”. However, the problem of forecasting available inventory of advertisement impressions for targeting profiles of attributes is complicated by the fact that there may be thousands of targeting attributes and that those attributes can be combined in many different ways to form targeting profiles.

What is needed is a way for an online publisher to make a granular forecast of available inventory of online advertisement impressions for targeting profiles of attributes. Such a system and method should be able to make accurate forecasts for any combination of those attributes in a fraction of a second.

### SUMMARY OF THE INVENTION

Briefly, the present invention provides a system and method for granular inventory forecasting of online advertisement impressions. An impression forecast data integrator may be provided that generates forecasted impression pools of advertisements for targeting impression attributes. The impression forecast data integrator may generate the forecasted impression pools by integrating impression pools of advertisements that share the same attributes and trend forecast data for web pages and advertisement placements on the web pages. The impression pools may include sample advertisement impressions that may be classified by categories. And the trend forecast data for each category may be retrieved that represents the inventory forecast for a category. An inventory forecast for an impression pool may then be calculated by minimizing an objective function of the squared errors of the difference between the daily forecasted inventory for each category and the sum of the daily forecasted inventory of all impression pools belonging to the. Then the inventory forecast of advertisement impressions during the time period may be output for each impression pool.

In an embodiment to generate forecasted impression pools of advertisements for targeting impression attributes, impression pools with unique attributes may be obtained that are classified by categories. The categories used to classify the impression pools may be obtained and an inventory forecast for each category may be obtained for a time period. In an embodiment, trend forecast data may be retrieved for untargeted inventory forecasting of advertisement impressions. The trend forecast data may be represented by a ratio of the number of forecasted impressions on a given date to the number of actual impressions on a reference date in the past. An inventory forecast for a category may then be determined by multiplying the number of impressions for each of the corresponding days in the past in the time period by the ratio in the trend data. A daily forecasted inventory may be produced for each impression pool by minimizing an objective function of the squared errors of the difference between the daily forecasted inventory for each category and the sum of the daily forecasted inventory for each impression pool.

The present invention may be used to forecast an inventory of online advertisement impressions to target many different profiles of attributes. The forecast of an inventory of online advertisement impressions generated may be used to target user attributes for online behavior and/or demographics including age, gender, and country. Or the forecast of an inventory of online advertisement impressions generated may be used to target browser attribute or type. The present invention may be used to make accurate forecast for any combination of thousands of targeting attributes.

Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components for granular inventory forecasting of online advertisement impressions, in accordance with an aspect of the present invention;

FIG. 3 is a flowchart for generally representing the steps undertaken in one embodiment for generating forecasted impression pools for granular inventory forecasting of online advertisement impressions, in accordance with an aspect of the present invention; and

FIG. 4 is a flowchart for generally representing the steps undertaken in one embodiment for generating forecasted impression pools for a periodic set of days for granular inventory forecasting of online advertisement impressions, in accordance with an aspect of the present invention.

### DETAILED DESCRIPTION

### Exemplary Operating Environment

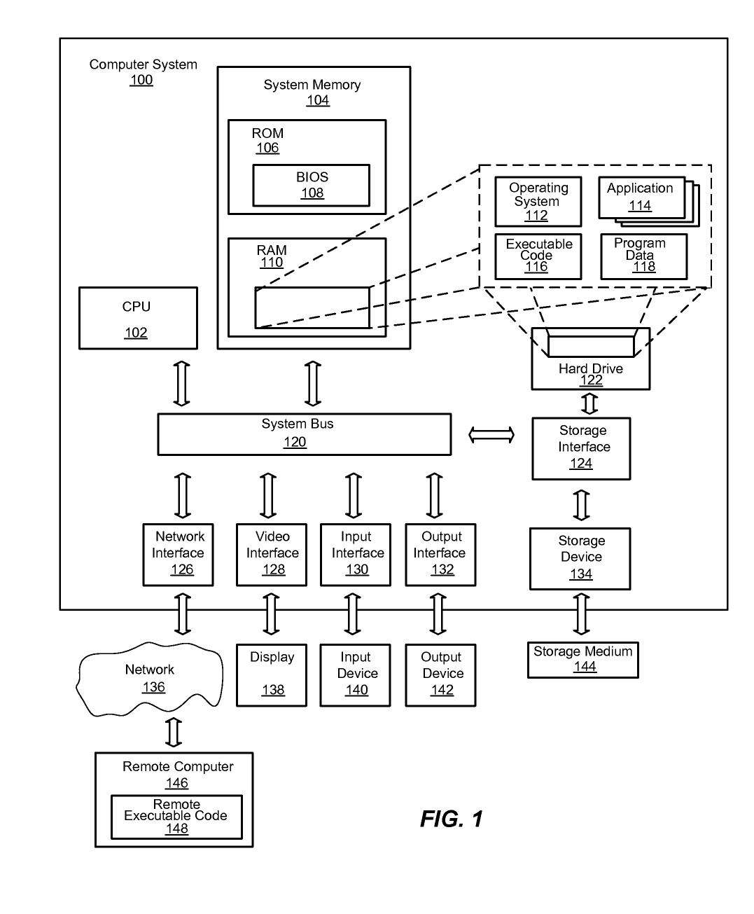

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be an optical disk drive or a magnetic disk drive that reads from or writes to a removable, a nonvolatile storage medium 144 such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used. Those skilled in the art will also appreciate that many of the components of the computer system 100 may be implemented within a system-on-a-chip architecture including memory, external interfaces and operating system. System-on-a-chip implementations are common for special purpose hand-held devices, such as mobile phones, digital music players, personal digital assistants and the like.

### Granular Inventory Forecasting of Online Advertisement Impressions

The present invention is generally directed towards a system and method for granular inventory forecasting of online advertisement impressions. An impression forecast data integrator may be provided that generates forecasted impression pools of advertisements by integrating impression pools of advertisements that share the same attributes and trend forecast data for web pages and advertisement placements on the web pages. Using the trend forecast data, an inventory forecast for a category may be calculated and an inventory forecast for an impression pool may be calculated. A daily forecasted inventory may then be produced for each impression pool by minimizing an objective function of the squared errors of the difference between the daily forecasted inventory for each category and the sum of the daily forecasted inventory of impression pools belonging to the category.

As will be seen, a forecast of an inventory of online advertisement impressions may be generated to target many different profiles of attributes. Thus, the present invention may provide a publisher with the capability to forecast available inventories of advertisement impressions for targeting different combinations of attributes before selling them to online advertisers. As used herein, a targeting profile of attributes means one or more attributes associated with web page properties, with web browser properties, with one or more users including demographics, online behavior, and so forth. As will be understood, the various block diagrams, flow charts and scenarios described herein are only examples, and there are many other scenarios to which the present invention will apply.

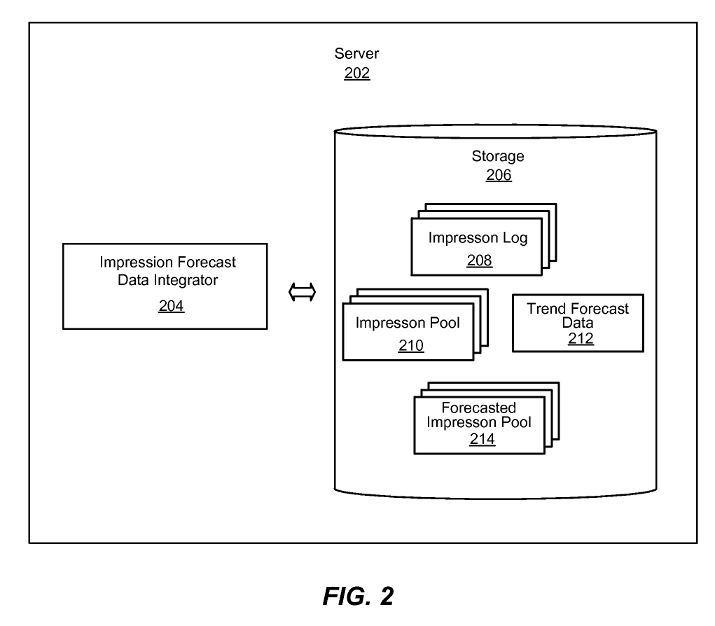

Turning to FIG. 2 of the drawings, there is shown a block diagram generally representing an exemplary architecture of system components for granular inventory forecasting of online advertisement impressions. The server 202 may be any type of computer system or computing device such as computer system 100 of FIG. 1. An impression forecast data integrator 204 may execute on the server 202 that may generate one or more forecasted impression pools 214 from impression pools 210 of advertisements that share the same attributes and trend forecast data 212 for web pages and advertisement placements on the web pages. The impression forecast data integrator 204 may also be any type of executable software code such as a kernel component, an application program, a linked library, an object with methods, or other type of executable software code. The impression forecast data integrator 204 may alternatively be a processing device such as an integrated circuit or logic circuitry that executes instructions represented as microcode, firmware, program code or other executable instructions that may be stored on a computer-readable storage medium. Those skilled in the art will appreciate that these components may also be implemented within a system-on-a-chip architecture including memory, external interfaces and an operating system.

The server 202 may be operably coupled to a computer-readable storage medium such as storage 206 that may store one or more impression logs 208, one of more impression pools 210, trend forecast data 212, and one or more forecasted impression pools 214. In an embodiment, the impression logs 208 may include recorded information of advertisement impressions served. The recorded information may include a web page ID, a user ID, an advertisement ID, a timestamp, and other information such as a web browser ID. Each of the impression pools 210 represent a collection of advertisement impressions that share the same attributes. The information gathered from the logs and other lookup tables, such as page hierarchy tables and visitor attribute tables, that may be incorporated in an impression pool includes: web page attributes such as properties of the page and the web page position of an advertisement; visitor attributes such as age, gender, country, behavioral interests; time attributes such as date and hour of the day; and other attributes such as attributes of a browser. Each of the impression pools 210 may also include a count of the total number of impressions that share the same attributes. The trend forecast data 212 may be represented by an inventory trend forecast table with columns including a web page property or collection of related web pages, web page position of an advertisement, and the ratio of the number of forecasted impressions on a given date to the number of actual impressions on a reference date in the past. Each of the forecasted impression pools 214 represent an impression pool 210 tagged with a reference to trend forecast data. The information that may be incorporated in a forecasted impression pool 214 may include the information from the impression pool 210, such as web page attributes, user attributes, time attributes, and impression count, and a reference to trend forecast data such as a pointer to a row in the inventory trend forecast table.

In general, an impression forecast data integrator 204 may generate forecasted impression pools 214 from impression pools 210 of advertisements that share the same attributes and trend forecast data 212 for web pages and advertisement placements on the web pages. The impression pools 210 may be created by extracting samples of historical impressions of advertisements served to online users from impression logs 208. The impression pools 210 of sample impressions may be classified by categories. For instance, the categories used to classify the impression pools may be display advertisement properties. As used herein, a display advertising property means a collection of related web pages that may have advertising space allocated for displaying advertisements. In particular, the attributes from an impression pool may be used to match a web page property or a group of related web pages in a collection of display advertisement properties. The trend forecast data for each category may then be retrieved to generate a daily forecasted inventory for each categorized impression pool. In an embodiment, the trend forecast data may be obtained from an inventory trend forecast table of records that include a display advertisement property and a ratio of the number of forecasted impressions on a given date to the number of actual impressions on a reference date in the past. The ratio of the number of forecasted impressions on a given date to the number of actual impressions on a reference date in the past may represent a forecast of inventory changes in the future.

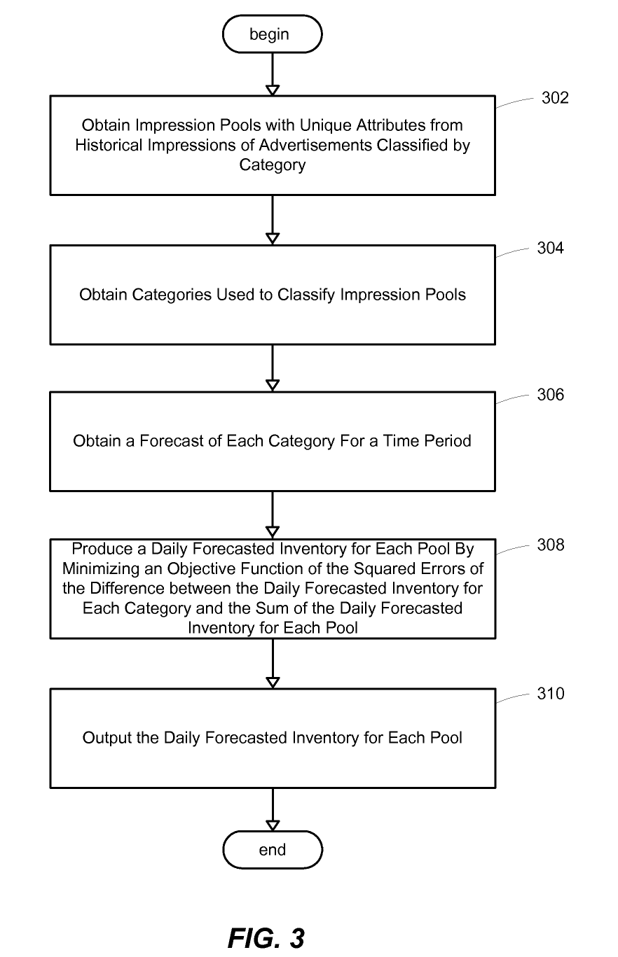

FIG. 3 presents a flowchart for generally representing the steps undertaken in one embodiment for generating forecasted impression pools for granular inventory forecasting of online advertisement impressions. At step 302, impression pools with unique attributes may be obtained that are classified by categories. In an embodiment, an impression pool represents a collection of advertisement impressions that share the same attributes, such as web page attributes including properties of the web page and the web page position of an advertisement, visitor attributes such as age, gender, country, behavioral interests, time attributes such as date and hour of the day, and other attributes such as attributes of a browser. An impression pool may also include a count of the total number of impressions in the impression pool. Each impression pool may be classified by a category. For instance, the categories used to classify the impression pools may be display advertisement properties. The attributes from each impression pool may be used to classify the impression pool by a display advertisement property. At step 304, the categories used to classify the impression pools may be obtained. In an embodiment, the categories of display advertisement properties used to classify the impression pools may be retrieved from an inventory trend forecast table of records that include the display advertisement properties.

At step 306, an inventory forecast for each category may be obtained for a time period. In an embodiment, trend forecast data may be retrieved for untargeted inventory forecasting of advertisement impressions for each category of display advertisement property. The trend forecast data may be represented by an inventory forecast trend table generated by applying time series analysis algorithms to historical impression counts as described in further detail by U.S. Pat. No. 6,801,945, entitled “SYSTEMS AND METHODS FOR PREDICTING TRAFFIC ON INTERNET SITES”. In particular, the trend forecast data may be obtained from an inventory trend forecast table of records that include a display advertisement property and a ratio of the number of forecasted impressions on a given date to the number of actual impressions on a reference date in the past. An inventory forecast for a category may then be determined by multiplying the number of impressions for each of the corresponding days in the past in the time period by the ratio in the trend data.

At step 308, a daily forecasted inventory may be produced for each impression pool by minimizing an objective function of the squared errors of the difference between the daily forecasted inventory for each category and the sum of the daily forecasted inventory of all impression pools belonging to the category. In general, a granular inventory forecast, denoted by f(p,d), for impression pool p and future date d may be calculated based on v(p), denoting the size of an impression pool, and F(c,d), denoting a total forecasted inventory for category c and future date d. Note that the size of an impression pool, v(p), may represent the number of historical impressions in pool p on historical date h. Consider the simplest case where each impression pool belongs to one and only one category. In this case, f(p,d)=v(p)·F(c,d)/Σₚ v(p) p ∈ P(c), where P(c) denotes the impression pools that belong to category c. Note that, the term Σₚ v(p), p ∈ P(c) above is the total impressions that belong to category c on some historical date h. F(c,d) is the total forecasted inventory for category c on some future date d. Hence, the term (F(c,d)/Σₚ v(p)) represents the future inventory trend relative to the past inventory available on date h. In this simple case, it is assumed that the inventory trend of a small impression pool is the same as the overall trend for the category. It is easy to prove that F(c,d)=Σₚ f(p,d) over all p ∈ P(c) .

Now consider a general case where an impression pool may belong to multiple categories. For example, an impression pool p₁ belongs to category c₁ and c₂, and impression pool p₂ belongs to category c₁, c₃ and c₄. In this general case, f(p,d) may be found by minimizing an objective function, which is the sum of squared errors of the differences between the daily forecasted inventory for each category c and the sum of the daily forecasted inventory for each impression pool p ∈ P(C): Σ_{c,d} Q(c)·(F(c,d)−Σₚ v(p)w(p,d)², where Q_{c} may denote a weighting constant per category and w(p,d) denotes the inventory trend of impression pool p relative to historical date h to be determined. In an embodiment where F(c,d) may be a forecast number obtained from time-series analysis, Q_{c} may be set to the variance of forecasting errors for category c, for instance.

There may be several different solutions implemented to solve the optimization problem of minimizing the objective function of the squared errors of the difference between the the daily forecasted inventory for each category c and the sum of the daily forecasted inventory for each impression pool p in category c. Given that there may be millions of impression pools and hundreds of categories in an embodiment, one suitable approach is to minimize the squared errors by gradient descent. For instance, w(p,d) may be initialized to w(p,d)=F(c,d)/V(c), where c may be any one of the categories to which pool p may belong and where V(c)=Σₚ v(p), p ∈ P(c), may be the size of an impression category. The derivatives of the squared errors may be computed with respect to w(p,d) and the resulting gradients followed. Many variations of gradient descent methods exist. One very efficient algorithm is the conjugate gradient method.

Upon finding a daily forecast of inventory changes that may occur in the future for each impression pool by minimizing the objective function of the squared error, the daily inventory forecast may be output at step 310. Those skilled in the art will appreciate that there may be many optimal solutions by minimizing an objective function of the squared errors of the difference between the daily forecasted inventory for each category and the sum of the daily forecasted inventory for each impression pool p in category c. For example, an optimal w(p,d) that is close to F(c,d)/V(c), where c is the most specific category to which impression pool p may belong, may be more desirable than other optimal solutions and may be computed by adding an additional term to the objective function as follows: Σ_{c,d} Q(c)·(F(c,d)−Σₚf(p,d))²+α·(Σ_{p,d}(R(p,d)−w(p,d))²), where R(p,d)=F(c,d)/V(c) for c that is the most specific category to which impression pool p may belong and where a may be a weighting constant.

Moreover, those skilled in the art will appreciate that impression pools belonging to the same category may be grouped in an embodiment to calculate an inventory forecast for an impression pool. For instance, impression pool p₁ may belong to categories c₁ and c₂, impression pool p₂ may belong to categories c₁ and c₃, and impression pool p₃ may belong to categories c₁ and c₂. Impression pools p₁ and p₃ can be grouped together as they belong to the same categories. But impression pool p₂ cannot be grouped together with either impression pools p₁ or p₃. Given that there may be millions of impression pools resulting in millions of variables w(p,d) that may be optimized, grouping impression pools belonging to the same category may reduce the number of variables involved in the optimization without changing the optimization problem. Consider the above example. By grouping impression pools p₁ and p₃ , w(p₁, d) may be forced to be same as w(p₂, d), and hence the number of variables to be optimized may be reduced.

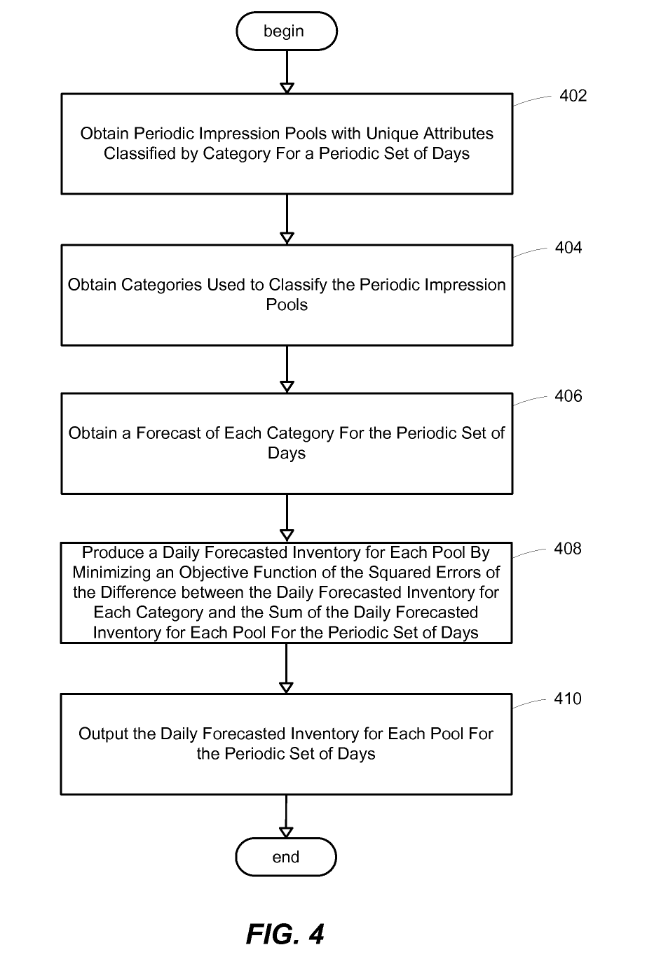

In addition to producing a daily forecasted inventory of online advertisement impressions for impression pools, an inventory forecast may be produced for weekdays, weekends, holidays, a particular shopping season, and other groups of days. FIG. 4 presents a flowchart for generally representing the steps undertaken in one embodiment for generating forecasted impression pools for a periodic set of days for granular inventory forecasting of online advertisement impressions. At step 402, periodic impression pools with unique attributes that are classified by categories may be obtained for a periodic set of days. For example, periodic impression pools may be obtained for any periodic set of days such as weekdays, weekends, a shopping season, summertime and so forth. In an embodiment, the periodic impression pools for the periodic set of days may be extracted from impression pools generated from samples of historical impressions of advertisements served to online users from impression logs. At step 404, the categories used to classify the periodic impression pools may be obtained. And at step 406, an inventory forecast for each category may be obtained for the periodic set of days. In an embodiment, trend forecast data may be retrieved for untargeted inventory forecasting of advertisement impressions for each category of display advertisement property. The trend forecast data may be represented by an inventory forecast trend table generated by applying time series analysis algorithms to historical impression counts as described in further detail by U.S. Patent No. 6,801,945, entitled “SYSTEMS AND METHODS FOR PREDICTING TRAFFIC ON INTERNET SITES”. At step 408, a daily forecasted inventory may be produced for each periodic impression pool for the periodic set of days by minimizing an objective function of the squared errors of the difference between the daily forecasted inventory for each category and the sum of the daily forecasted inventory for each periodic impression pool for the periodic set of days. In an embodiment, a daily forecasted inventory, f(p,d), may be calculated for a periodic set of days, d ∈ H, by the following equation: Σ_{c,d} Q(c)·(F(c,d)−Σₚ v(p)w(p,d))², where Q_{c} may denote a weighting constant per category and w(p,d) denotes the inventory trend of periodic impression pool p relative to historical date h to be determined. At step 410, the daily inventory forecast for each periodic impression pool for the periodic set of days may be output.

Those skilled in the art will appreciate that some pools may be used to forecast inventories for weekdays, and other pools may be used to forecast an inventory of impression for weekends. To account for seasonal differences, some impression pools may be used to forecast inventories for the shopping season, other impression pools may be used to forecast inventories of impressions for the summer time, and yet other impression pools may be used to forecast inventories for the rest of the year.

Importantly, the forecast of an inventory of online advertisement impressions generated may be used to target many different profiles of attributes. For instance, the forecast of an inventory of online advertisement impressions generated may be used to target web page attributes such as properties of the page and the web page position of an advertisement may be used. The forecast of an inventory of online advertisement impressions generated may be used to target user attributes for online behavior and/or demographics including age, gender, and country. Or the forecast of an inventory of online advertisement impressions generated may be used to target browser attribute or type. The present invention may be used to make accurate forecast for any combination of thousands of targeting attributes. Thus, the present invention may provide a publisher with the capability to forecast available inventories of advertisement impressions for targeting different combinations of attributes before selling them to online advertisers who, for instance, would like to target users visiting certain web pages with certain demographics, geographies, behavioral interests, as well as many other attributes. Those skilled in the art will appreciate that the present invention may generate a forecast of an inventory of online advertisement impressions that may be used to target any impression attributes including page attributes, user attributes, browser attributes, time attributes, and so forth.

As can be seen from the foregoing detailed description, the present invention provides an improved system and method for generating forecasted impression pools for granular inventory forecasting of online advertisement impressions. Impression pools of advertisements sharing the same attributes and trend forecast data for web pages and advertisement placements on the web pages may be integrated to generate the forecasted impression pools. Impression pools with unique attributes may be obtained that are classified by categories. The categories used to classify the impression pools may be obtained, and an inventory forecast for each category may be obtained for a time period. A daily forecasted inventory may then be produced for each impression pool by minimizing an objective function, and the daily inventory forecast for each pool may be output. Moreover, an inventory forecast may be produced for weekdays, weekends, holidays, a particular shopping season, and other groups of days. As a result, the system and method provide significant advantages and benefits needed in contemporary computing and in online applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer system for forecasting an inventory of online advertising impressions, comprising:
impression forecast data integrator that generates a plurality of forecasted impression pools from a plurality of impression pools and trend forecast data; and
a storage operably coupled to the impression forecast data integrator that stores the plurality of impression pools and the trend forecast data.

2. The system of claim 1 wherein the storage further comprises a storage that stores a plurality of forecasted impression pools.

3. A computer-readable storage medium having computer-executable components comprising the system of claim 1.

4. A computer-implemented method for forecasting an inventory of online advertising impressions, comprising:
obtaining a plurality of impression pools classified by category, each impression pool including a plurality of online advertisement impressions with similar attributes;
obtaining a forecast of each category of a plurality of categories used to classify the plurality of impression pools;
producing a forecasted inventory for each of the plurality of impression pools by minimizing an objective function of squared errors of a difference between a daily forecasted inventory for each of the plurality of categories and a sum of a daily forecasted inventory for each of the plurality of impression pools; and
outputting the forecasted inventory for each of the plurality of impression pools.

5. The method of claim 4 further comprising obtaining the plurality of categories used to classify the plurality of impression pools.

6. The method of claim 4 further comprising grouping the plurality of impression pools belonging to a same category of the plurality of categories.

7. The method of claim 1 wherein each impression pool including the plurality of online advertisement impressions with similar attributes comprises an impression pool including the plurality of online advertisement impressions with similar web page attributes.

8. The method of claim 1 wherein each impression pool including the plurality of online advertisement impressions with similar attributes comprises an impression pool including the plurality of online advertisement impressions with similar user attributes.

9. The method of claim 1 wherein each impression pool including the plurality of online advertisement impressions with similar attributes comprises an impression pool including the plurality of online advertisement impressions with similar web browser attributes.

10. The method of claim 1 wherein obtaining the forecast of each category of the plurality of categories used to classify the plurality of impression pools comprises obtaining a ratio of a number of a plurality of forecasted impressions on a given date to a number of a plurality of actual impressions on a reference date in the past.

11. The method of claim 1 wherein producing a forecasted inventory for each of the plurality of impression pools by minimizing an objective function of squared errors of a difference between a daily forecasted inventory for each of the plurality of categories and a sum of a daily forecasted inventory for each of the plurality of impression pools comprises calculating an inventory forecast for a category by multiplying the number of impressions for each of the corresponding days in the past in the time period by the ratio in the trend data.

12. The method of claim 1 wherein producing a forecasted inventory for each of the plurality of impression pools by minimizing an objective function of squared errors of a difference between a daily forecasted inventory for each of the plurality of categories and a sum of a daily forecasted inventory for each of the plurality of impression pools comprises calculating an additional term to each of the squared errors that represents a ratio of a daily forecasted inventory for a category to the size of the category that is the most specific category in which each of the plurality of impression pools is classified.

13. The method of claim 1 wherein producing a forecasted inventory for each of the plurality of impression pools by minimizing an objective function of squared errors of a difference between a daily forecasted inventory for each of the plurality of categories and a sum of a daily forecasted inventory for each of the plurality of impression pools comprises multiplying the squared errors of the difference between the daily forecasted inventory for each of the plurality of categories and a sum of a daily forecasted inventory for each of the plurality of impression pools by a weighting constant per each of the plurality of categories.

14. The method of claim 1 wherein producing a forecasted inventory for each of the plurality of impression pools by minimizing an objective function of squared errors of a difference between a daily forecasted inventory for each of the plurality of categories and a sum of a daily forecasted inventory for each of the plurality of impression pools comprises minimizing the objective function of the squared errors of the difference between the daily forecasted inventory for each of the plurality of categories and the sum of the daily forecasted inventory for each of the plurality of impression pools by a method of gradient descent.

15. The method of claim 1 wherein obtaining the plurality of impression pools classified by category comprises obtaining a plurality of periodic impression pools for a periodic set of days classified by category.

16. The method of claim 1 wherein producing the forecasted inventory for each of the plurality of impression pools by minimizing the objective function of the squared errors of the difference between the daily forecasted inventory for each of the plurality of categories and the sum of the daily forecasted inventory for each of the plurality of impression pools comprises producing a forecasted inventory for each of a plurality of periodic impression pools by minimizing the objective function of the squared errors of the difference between the daily forecasted inventory for each of the plurality of categories and the sum of the daily forecasted inventory for each of the plurality of periodic impression pools for a periodic set of days.

17. A computer-readable medium having computer-executable instructions for performing the method of claim 4.

18. A computer system for forecasting an inventory of online advertising impressions, comprising:
means for obtaining a plurality of impression pools classified by category, each impression pool including a plurality of online advertisement impressions with similar attributes;
means for obtaining a forecast of each category of a plurality of categories used to classify the plurality of impression pools;
means for producing a forecasted inventory for each of the plurality of impression pools by minimizing an objective function of squared errors of a difference between a daily forecasted inventory for each of the plurality of categories and a sum of a daily forecasted inventory for each of the plurality of impression pools; and
means for outputting the forecasted inventory for each of the plurality of impression pools.

19. The system of claim 18 further comprising means for grouping the plurality of impression pools belonging to a same category of the plurality of categories.

20. The system of claim 18 wherein means for producing a forecasted inventory for each of the plurality of impression pools by minimizing an objective function of squared errors of a difference between a daily forecasted inventory for each of the plurality of categories and a sum of a daily forecasted inventory for each of the plurality of impression pools comprises means for producing the forecasted inventory for each of a plurality of periodic impression pools by minimizing the objective function for a periodic set of days
